(19) United States
(12) Patent Application Publication
(10) Pub. No.: US 2026/0164395 A1
(43) Pub. Date: Jun. 11, 2026

(54) SYSTEMS AND METHODS FOR TIME INFORMATION INDICATION IN POSITIONING

(71) Applicant: ZTE CORPORATION, Shenzhen (CN)

(72) Inventors: Fangyu CUI, Shenzhen (CN); Nan ZHANG, Shenzhen (CN); Yachao YIN, Shenzhen (CN); Junli LI, Shenzhen (CN)

(73) Assignee: ZTE CORPORATION, Shenzhen (CN)

(21) Appl. No.: 19/181,900

(22) Filed: Apr. 17, 2025

Related U.S. Application Data
(63) Continuation of application No. PCT/CN2023/086858, filed on Apr. 7, 2023.

(51) Int. Cl. H04W 64/00; H04L 5/00; H04W 72/23

(52) U.S. Cl. CPC H04W 64/00; H04L 5/0048; H04W 72/23

(57) ABSTRACT

Presented are systems and methods for time information indication in positioning. A wireless communication device may receive an indication of resources configured for a pair of reference signals comprising a first reference signal (RS) and a second RS from a core network (CN). The wireless communication device may determine a positioning-related metric using time information corresponding to the resources configured for the pair of reference signals.

### CROSS-REFERENCE TO RELATED APPLICATION

This application claims the benefit of priority under 35 U.S.C. § 120 as a continuation of International Patent Application No. PCT/CN2023/086858, filed on Apr. 7, 2023, the disclosure of which is incorporated herein by reference in its entirety.

### TECHNICAL FIELD

The disclosure relates generally to wireless communications, including but not limited to systems and methods for time information indication in positioning.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A wireless communication device (e.g., a UE) may receive an indication of resources (e.g., time offset, timestamp) configured for a pair of reference signals comprising a first reference signal (RS) and a second RS (e.g., DL RS and UL RS (e.g., PRS and SRS)) from a core network (CN). The wireless communication device may determine (e.g., calculate) a positioning-related metric (e.g., a UE Rx-Tx time difference, a gNB Rx-Tx time difference, a reference signal time difference (RSTD)) using time information corresponding to the resources configured for the pair of reference signals. In some embodiments, in a LPP protocol, a CN (e.g., location server) may indicate NR-DL-PRS-AssistanceData to UE, which includes a time and frequency resource configuration for PRS. On the other hand, eNB/gNB's measurement can be based on SRS transmitted by the UE. Hence, before measurement, the eNB/gNB may configure the time and frequency resource for SRS to UE using SRS-Config. The eNB/gNB may exchange the SRS configuration with the CN. The indication of resources may include providing/indicating/configuring a time offset that is used to select/identify/determine the resources for the pair of reference signals, e.g., select the resources from those resources that are already configured. The indication of resources may also include providing/indicating/configuring the resource IDs for the pair of reference signals to select/identify/determine the resources, e.g., select the resources from those resources that are already configured.

In some embodiments, the UE may know detailed PRS and SRS resources. The pairing relationship may be unknown. If a CN indicates a time offset (e.g., using number of subframes) or the resource IDs, the UE can identify which PRS and SRS are paired and then can determine the detailed resources. In certain embodiments, there may be no need to let CN indicate the detailed resources again in additional signaling.

In some embodiments, the indication of resources may comprise at least one of: an indication of one or more resources configured for the first RS, and one or more resources configured for the second RS. The indication of resources may comprise a resource identifier (ID), selected from a plurality of resource IDs corresponding to a plurality of pairs of reference signals.

In some embodiments, the resources may include periodic resources, aperiodic resources, or both periodic and aperiodic resources. The pair of reference signals can be determined according to one of following approaches: the second RS is a nearest RS to the first RS; the first RS is an RS of a first type (e.g., DL RS (e.g. PRS)) located closest to and after a reference point (e.g., SFN #0 slot #0), and the second RS is an RS of a second type (e.g., UL RS (e.g., SRS)) located closest to and after the reference point; the first RS and the second RS are separated by a defined time offset; the first RS and the second RS are identified by respective resource IDs; or the first RS and the second RS are identified by respective timestamps (e.g., SFN and slot number for each RS) or time indications.

In some embodiments, when a resource for the first RS is an aperiodic resource, the pair of reference signals can be determined according to one of following approaches: the second RS is a nearest RS to first RS with the aperiodic resource; the second RS is a RS identified by a timestamp or time indication; or the second RS is a RS identified by a defined time offset with respect to first RS. The indication of resources may comprise at least one of: an indication of a resource ID of the first RS; an indication of a resource ID of the second RS; an indication of a timestamp or time indication (e.g., SFN and slot number for each RS) of the first RS; an indication of a timestamp or time indication of the second RS; an indication of a timestamp or time indication of the first RS, with respect to the second RS; an indication of a timestamp or time indication of the second RS, with respect to the first RS; or a defined time offset separating the first RS and the second RS. Each timestamp or time indication of a corresponding RS may comprise at least one of: a hyper frame number (HFN); a system frame number (SFN); a subframe number; a slot number; a symbol number; or an absolute time with granularity of a defined number of microseconds or nanoseconds. The defined offset may comprise at least one of: a hyper frame number (HFN); a system frame number (SFN); a subframe number; a slot number; a symbol number; or an absolute time with granularity of a defined number of seconds, milliseconds, microseconds or nanoseconds.

In some embodiments, the CN may communicate to the wireless communication node, the indication of resources (e.g., time offset, timestamp) configured for the pair of reference signals.

In some embodiments, the positioning-related metric (e.g., UE rx-tx time difference, gNB rx-tx time difference, RSTD) may comprise at least one of: a user equipment or the wireless communication device's (UE) receive-transmit (Rx-Tx) time difference between subframes carrying the reference signals; a UE Rx-Tx time difference between a received time of a downlink (DL) subframe carrying the first RS, and a transmit time of a nearest or corresponding uplink (UL) subframe; a UE Rx-Tx time difference between a received time of a DL subframe, and a transmit time of an UL subframe carrying the second RS, and the DL subframe is a DL subframe nearest or corresponding to the UL subframe; a base station or the wireless communication node's (gNB) Rx-Tx time difference between the subframes carrying the reference signals; a gNB Rx-Tx time difference between a received time of an UL subframe carrying the second reference signal and a transmit time of a nearest or corresponding DL subframe; a round trip time (RTT) between the wireless communication device and the wireless communication node; a relative time of arrival (RTOA); an DL or UL angle of departure (AoD); an UL or DL angle of arrival (AoA); or a reference signal time difference (RSTD). In some embodiments, some of the abovementioned metrics (e.g., gNB Rx-Tx time difference, RTOA, UL-AoA, DL-AoD) can be determined/calculated by the wireless communication node (e.g., a gNB, a BS, a transmit-receive point, or a satellite) and/or the wireless communication device.

In some embodiments, the first signal may comprise a downlink RS or a positioning RS (PRS), and the second signal comprises an uplink RS or a sounding RS (SRS). The first signal may comprise a first downlink or uplink RS, and the second signal comprises a second downlink or uplink RS.

In some embodiments, a core network (CN) may send an indication (e.g., time offset, timestamp) of resources configured for a pair of reference signals comprising a first reference signal (RS) and a second RS (e.g., DL RS and UL RS (e.g., PRS and SRS)). The wireless communication device may determine a positioning-related metric (e.g., UE rx-tx time difference, gNB rx-tx time difference, RSTD) using time information corresponding to the resources configured for the pair of reference signals.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example multi-cell round trip time (multi-RTT) method, in accordance with some embodiments of the present disclosure;

FIG. 4 illustrates an example user equipment (UE) Rx-Tx time difference in terrestrial network (TN) positioning, in accordance with some embodiments of the present disclosure;

FIG. 5 illustrates an example next generation node B (gNB) Rx-Tx time difference in terrestrial network (TN) positioning, in accordance with some embodiments of the present disclosure;

FIG. 6 illustrates a sequence diagram for signaling procedure in multi-cell round trip time (multi-RTT), in accordance with some embodiments of the present disclosure;

FIG. 7 illustrates an example non-terrestrial network (NTN), in accordance with some embodiments of the present disclosure;

FIG. 8 illustrates an example of positioning by a single satellite/aerial vehicle, in accordance with some embodiments of the present disclosure;

FIG. 9 illustrates an example modified user equipment (UE) Rx-Tx time difference and next generation node B (gNB) Rx-Tx time difference, in accordance with some embodiments of the present disclosure; and

FIG. 10 illustrates a flow diagram for time information indication in positioning, in accordance with an embodiment of the present disclosure.

### DETAILED DESCRIPTION

### 1. Mobile Communication Technology and Environment

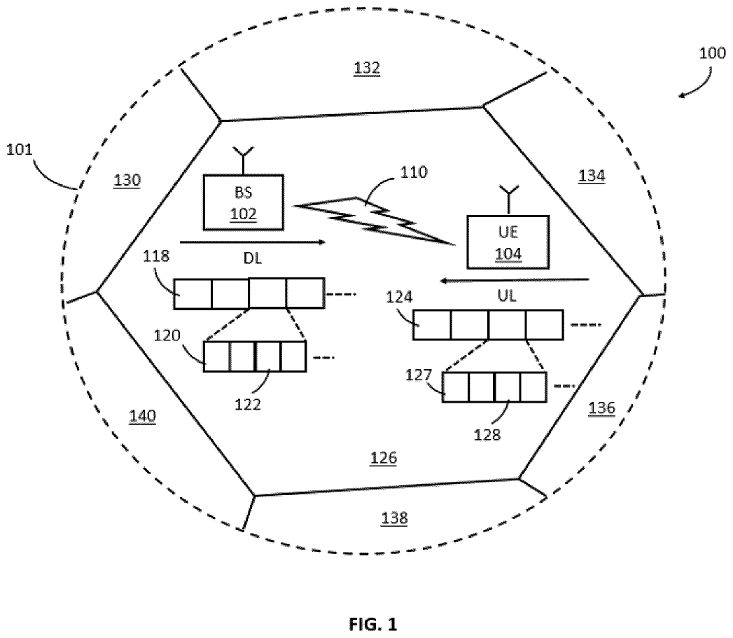

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

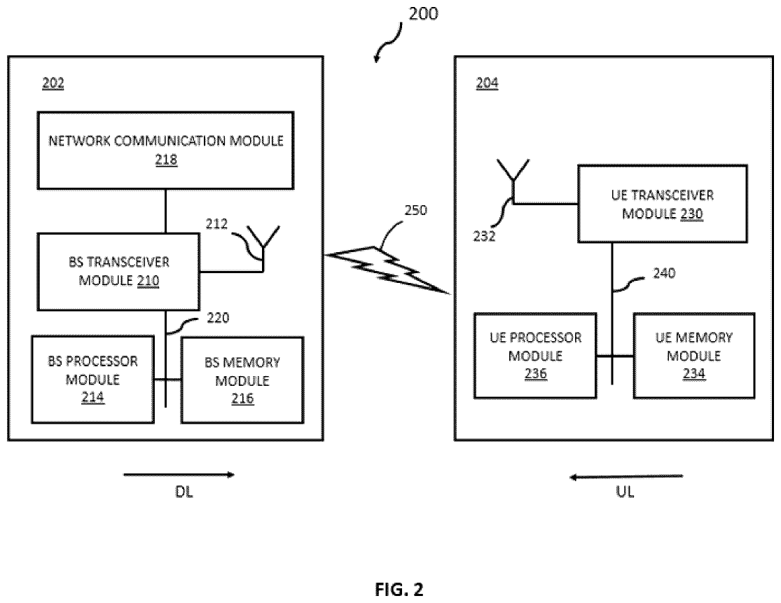

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Time Information Indication in Positioning

In new radio (NR), a dynamic system can be supported (e.g., non-terrestrial network (NTN) or vehicle to X (V2X)). There may be no fixed anchor points for positioning. How to verify a location of a user equipment (UE) in NTN can be performed. A sidelink (SL) positioning which takes V2X into consideration may be also studied. Reusing a radio access technology (RAT)-dependent positioning procedure to obtain the UE location can be a baseline solution. However, due to potential high satellite mobility in NTN and vehicle mobility in V2X, time information of measurement for positioning can be accurately known. Otherwise, an uncertainty of anchor point position may cause significant positioning error, which may not be expected. However, in a TN positioning, the time information can be generally indicated with a slot granularity, which may not be enough for high mobility scenarios. Further, a time gap between reference signals may be known to handle a timing drift between different measurements. Hence, in the present disclosure, an enhancement on time information indication in positioning can be performed.

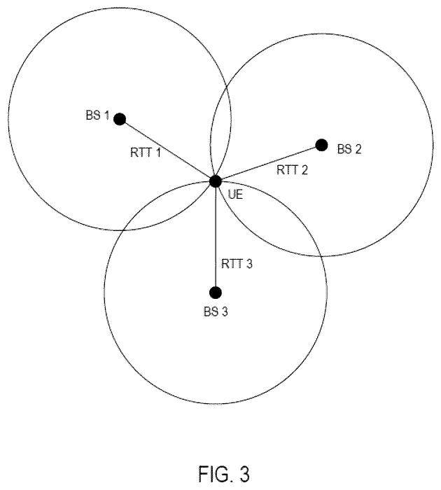

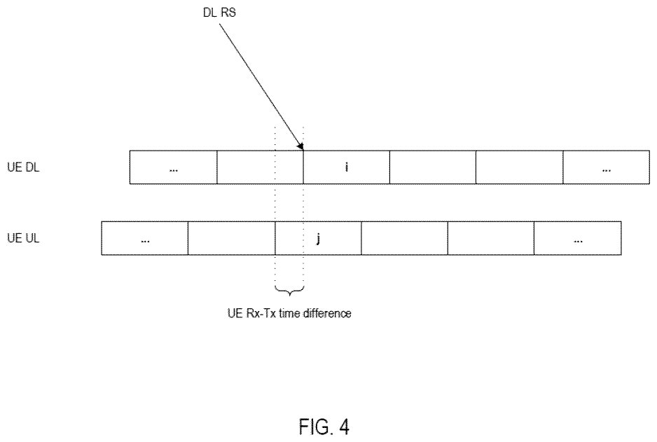

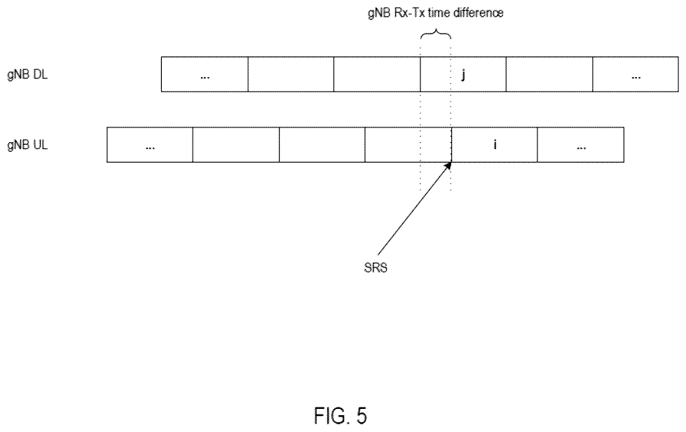

For example, the multi-RTT method as shown in FIG. 3 is a positioning method in a TN. In a TN positioning, a location management function (LMF) or UE may collect measurement results based on reference signaling (e.g., a positioning reference signal (PRS) and/or a sounding reference signal (SRS)) to estimate an angle or delay of propagation with respect to different anchor points. The UE location can be estimated using a geometric calculation. For example, in multi-RTT method as shown in FIG. 3, a UE may measure a UE Rx-Tx time difference based on a downlink (DL) reference signal (RS) (e.g., a PRS, or a channel state information reference signal (CSI-RS)) and a gNB may measure the gNB Rx-Tx time difference based on a SRS. The LMF can estimate the RTT based on the measured UE Rx-Tx time difference and gNB Rx-Tx time difference, and can calculate the UE location. The definition of UE Rx-Tx time difference in NR TN positioning can be shown as Table 1 and FIG. 4. While the definition of gNB Rx-Tx time difference in NR TN positioning can be as shown in Table 2 and FIG. 5

TABLE 1
Definition of UE Rx-Tx time difference in TN positioning. FIG. 4 illustrates an
example user equipment (UE) Rx-Tx time difference in terrestrial network (TN)
positioning, in accordance with some embodiments of the present disclosure.

| | |
|---|---|
| Definition | The UE Rx − Tx time difference can be defined as T_{UE-RX} − T_{UE-TX} |
| | Where: |
| | T_{UE-RX} can be the UE received timing of downlink subframe #i from a |
| | Transmission Point (TP), defined by the first detected path in time. |
| | T_{UE-TX} can be the UE transmit timing of uplink subframe #j that is closest in |
| | time to the subframe #i received from the TP. |
| | Multiple DL PRS or CSI-RS for tracking resources, as instructed by higher |
| | layers, can be used to determine the start of one subframe of the first arrival path |
| | of the TP. |
| | For frequency range 1, the reference point for T_{UE-RX} measurement can be the |
| | Rx antenna connector of the UE and the reference point for T_{UE-TX} |
| | measurement can be the Tx antenna connector of the UE. For frequency range |
| | 2, the reference point for T_{UE-RX} measurement can be the Rx antenna of the UE |
| | and the reference point for T_{UE-TX} measurement can be the Tx antenna of the |
| | UE. |

TABLE 2
Definition of gNB Rx-Tx time difference in TN positioning. FIG. 5 illustrates an
example next generation node B (gNB) Rx-Tx time difference in terrestrial network
(TN) positioning, in accordance with some embodiments of the present disclosure.

| | |
|---|---|
| Definition | The gNB Rx − Tx time difference can be defined as T_{gNB-RX} − T_{gNB-TX} |
| | Where: |
| | T_{gNB-RX} can be a Transmission and Reception Point (TRP) received timing of |
| | uplink subframe #i containing SRS associated with UE, defined by a first |
| | detected path in time. |
| | T_{gNB-TX} can be a TRP transmit timing of downlink subframe #j that is closest in |
| | time to the subframe #i received from the UE. |
| | Multiple SRS resources can be used to determine the start of one subframe |
| | containing SRS. |
| | The reference point for T_{gNB-RX} can be: |
| | for type 1-C base station: the Rx antenna connector, |
| | for type 1-O or 2-O base station: the Rx antenna (e.g., the centre location |
| | of the radiating region of the Rx antenna), |
| | for type 1-H base station: the Rx Transceiver Array Boundary connector. |
| | The reference point for T_{gNB-RX} can be: |
| | for type 1-C base station: the Tx antenna connector, |
| | for type 1-O or 2-O base station: the Tx antenna (e.g., the centre location |
| | of the radiating region of the Tx antenna), |
| | for type 1-H base station: the Tx Transceiver Array Boundary connector. |

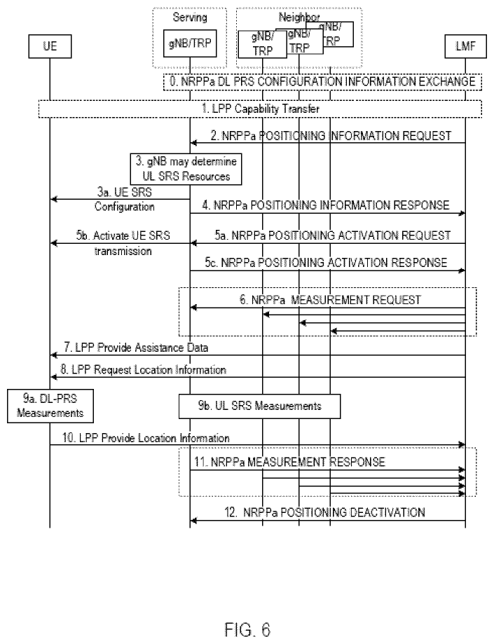

From above description, there may be information exchange between a LMF and a UE/gNB. The LMF may indicate the UE DL RS resource for measurement. The UE may report LMF a measurement result. Similarly, the LMF may also indicate the measurement request to the gNB. The gNB may transfer a reference signal resource configuration and/or a measurement result to the LMF. The procedure of multi-RTT can be shown in FIG. 6. FIG. 6 illustrates a sequence diagram for signaling procedure in multi-cell round trip time (multi-RTT), in accordance with some embodiments of the present disclosure.

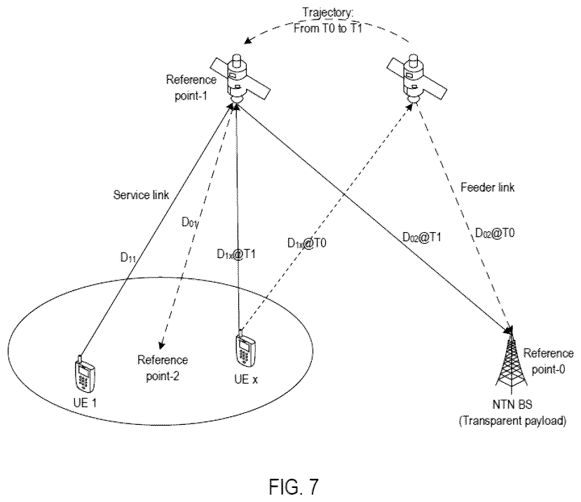

FIG. 7 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an evolved Node B (eNB), a wireless communication node, etc.) and a satellite can be a feeder link and can be common for all UEs within the same cell.

In a NTN, a satellite position can be considered as anchor points for positioning, which is similar to a TRP in a TN. However, unlike the TRP in the TN, satellite networks may exhibit high mobility, particularly in low earth orbit (LEO) scenarios where anchor points can move over time. The UE may perform autonomous timing advance (TA) pre-compensation to maintain UL synchronization. As a result, for measurements at different instances, a corresponding timing may be changed. In a multi-RTT method, the measured UE Rx-Tx time difference and gNB Rx-Tx time difference may correspond to different UL timing. Without taking the timing drift into account, the accuracy of the obtained round-trip time (RTT) may be affected, leading to a degradation in positioning performance.

### Implementation Example 1: Enhanced Timestamp

In a dynamic system (e.g., NTN and V2X), anchor points may be moving due to high mobility. As a result, accurate time information for measurements may be needed in positioning, since a geometry relationship between a target device and anchor points can be continuously changing along with time. In a positioning, a NR-TimeStamp-r16 as shown below can used to illustrate time information of measurement result.

-- ASN1START
NR-TimeStamp-r16 ::= SEQUENCE {

| dl-PRS-ID-r16 | INTEGER (0..255), | |
|---|---|---|
| nr-PhysCellID-r16 | NR-PhysCellID-r16 | OPTIONAL, -- Need ON |
| nr-CellGlobalID-r16 | NCGI-r15 | OPTIONAL, -- Need ON |
| nr-ARFCN-r16 | ARFCN-ValueNR-r15 | OPTIONAL, -- Need ON |

| | |
|---|---|
| nr-SFN-r16 | INTEGER (0..1023), |
| nr-Slot-r16 | CHOICE { |
| scs15-r16 | INTEGER (0..9), |
| scs30-r16 | INTEGER (0..19), |
| scs60-r16 | INTEGER (0..39), |
| scs120-r16 | INTEGER (0..79) |

},
...
}
-- ASN1STOP

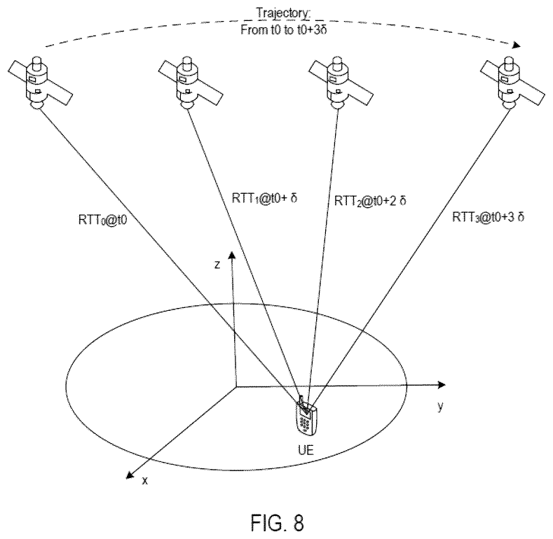

The slot level granularity may not be enough for high mobility scenarios. Hence, finer granularity may be added. Moreover, in a single-satellite based positioning, satellite positions at different time instances may be regarded as different anchor points as shown in FIG. 8. In order to obtain well spread-out anchor points, the measurement may be performed multiple times with a large time interval (e.g., tens of even hundreds of seconds). To avoid ambiguity in such case, hyper frame number may be added. Therefore, an enhanced timestamp may include at least one of following in addition to the information in NR-TimeStamp-r16: a symbol number, a hyper frame number (HFN or hyper SFN) (e.g., increments by 1 with every complete cycle of 1023 SFN values), or an absolute time with granularity of X microseconds/nanoseconds. X can be a predefined value or configured by the network through a system information block (SIB) broadcast/radio resource control (RRC) signaling.

On the other hand, ephemeris and/or common TA parameters in a NTN can be associated with certain epoch time and validity duration. UE autonomous TA pre-compensation based on ephemeris and/or common TA can be considered/thought accurate enough to ensure UL synchronization during the validity duration. However, it's up to UE implementation to determine when to update the ephemeris and common TA parameters. The UE applied ephemeris and common TA parameters for pre-compensation may not be exactly the same as the newest parameters at the gNB or the LMF.

In order to resolve the misalignment, at least one of following solutions may be considered.
(1) The UE may transfer the ephemeris and/or common TA parameters applied by it when transmitting UL RS and/or measuring DL RS together with the epoch time to the LMF. The LMF may derive the satellite position and/or common TA value assumed by UE during measurement by using the ephemeris and common TA parameters, epoch time, and/or timestamp indicating when the measurement is performed.
(2) The UE may directly report the satellite position and/or common TA value when the UE performs the measurement.
(3) The gNB may transfer the ephemeris and/or common TA parameters together with the epoch time to the LMF. The LMF may derive the satellite position and/or common TA value assumed by UE during measurement by using the ephemeris and common TA parameters, epoch time, and/or timestamp indicating when the measurement is performed. In order to ensure that the ephemeris, common TA parameters, or epoch time applied by UE are same as that transferred from the gNB to the LMF, some additional assumptions may be performed. For example, the UE can always acquire the newest ephemeris, common TA parameters, or epoch time before transmitting UL RS, measuring DL RS, or transferring TA value to be transferred to the LMF.
(4) The gNB may directly report the satellite position and/or common TA value determined based on the configuration of DL RS and/or UL RS configuration. For example, the gNB may know/be aware of the time when the UE can perform DL RS measurement and/or UL RS transmission based on the configuration of RS resources. Then the gNB may directly calculate the corresponding satellite position and/or common TA value and may transfer to the LMF.

The solution of transferring whole ephemeris and common TA parameters may require larger signaling overhead for one transmission. However, since the LMF can derive the variation of satellite position and common TA, the ephemeris and common TA parameters and epoch time may be reported only once if multiple measurements are performed during same validity duration, which may save the signaling on the contrary.

### Implementation Example 2: Indication of Timing Relationship Between Reference Signals

In a NR multi-RTT method, there may be no coupling relationship between a DL RS and a UL RS. The UE may estimate UE Rx-Tx time difference only based on a DL RS (e.g., PRS, CSI-RS, or SSB). While the gNB may estimate the gNB Rx-Tx time difference only based on UL RS (e.g., SRS). There may be no constraint between the two measurements. The motivation is that the UL timing of DL RS measurement and UL RS transmission during the positioning can be stable in TN due to fixed anchor points (e.g., TRPs). As a result, the UE Rx-Tx time difference and gNB Rx-Tx time difference measured at different time instances can be combined to estimate the RTT by assuming same UL timing. Moreover, measurements of multiple DL/UL RSs can be filtered or averaged to improve measurement accuracy.

However, in a dynamic system (e.g., NTN or V2X), a timing may drift fast due to moving anchor points (e.g., satellites, vehicles). The UL timing may not able to be considered stable during the positioning. Especially for NTN, UE autonomous TA pre-compensation can be assumed to handle the propagation delay variation due to satellite mobility. In such case, the TA can vary from the time of DL RS measurement to the time of UL RS transmission. The detailed changed value can be unknown to the gNB. As a result, the RTT directly calculated by combining the UE Rx-Tx time difference and gNB Rx-Tx time difference can include an unknown UL timing error, which degrades positioning performance.

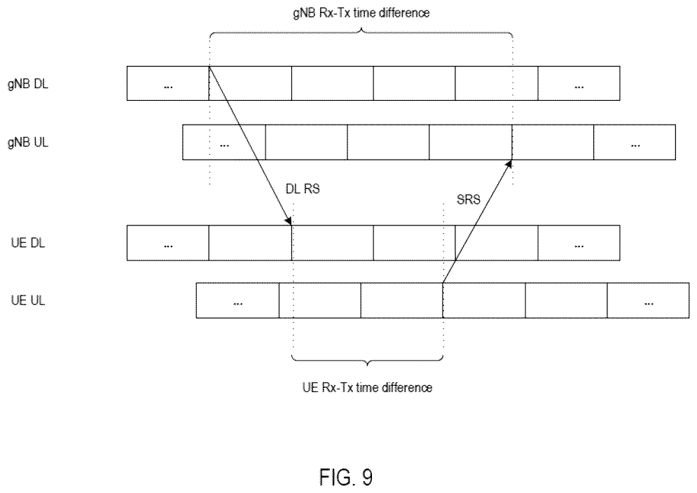

To handle timing variation during positioning, at least one of following potential solutions may be considered.
(1) An indication of resources can be configured for a pair of reference signals comprising a DL RS and a UL RS for measurements. The definition of UE/gNB Rx-Tx time difference can be modified. The UE Rx-Tx time difference is modified as the time difference between receiving time of a DL RS and transmitting time of a UL RS as shown in FIG. 9. Correspondingly, gNB Rx-Tx time difference can be modified as receiving time of the UL RS and transmitting time of the DL RS. The RTT can be estimated based on the UE Rx-Tx time difference and gNB Rx-Tx time difference. Since a real RTT is estimated, there may be no need to consider the UL timing adjustment.
(2) The measurement at the UE can be only based on DL RS, and the gNB can be only based on UL RS. The timing offset between the UL RS and DL RS can be known. The UE may estimate the UL timing variation and/or TA variation between DL RS receiving and UL RS transmitting (e.g., with the help of ephemeris and common TA parameters in NTN). The UE may report the UL timing variation and/or TA variation to gNB, or may transfer the UL timing variation and/or TA variation to the LMF, or may directly adjust the measured UE Rx-Tx time difference to be transferred to the LMF. The error caused by timing variation can be corrected. To accommodate long propagation delay in a NTN, the definition of UE Rx-Tx time difference may be modified to extend value range (e.g., modified from the time difference between DL subframe #i and nearest UL subframe #j to the time difference between DL subframe #i and corresponding UL subframe #i). The gNB Rx-Tx time difference may also be modified to extend value range (e.g., modified as the time difference between UL subframe #i and corresponding DL subframe #i). But still, the measurement at UE can be only based on DL RS and measurement at gNB can be only based on UL RS, which are different from solution 1 but similar as in TN positioning.
(3) The definition of UE Rx-Tx time difference can be modified. UE Rx-Tx time difference can be defined as the time difference between UE UL RS transmitting time and receiving time of corresponding DL subframe/slot. The UE Rx-Tx time difference may be obtained by the TA applied for UL RS transmission. The UE may further adjust the UE Rx-Tx time difference using the UL timing error between reference UL time obtained based on TA and actual UL transmit time. Since the UE and the gNB Rx-Tx time difference are based on same UL RS, there may be no need to consider timing variation.
(4) TA can be kept or UL timing can be unchanged for DL RS receiving and UL RS transmitting. The UL timing error can be avoided. If the TA or UL timing is unchanged for all UL transmission, normal UL transmission may not be scheduled before finishing UL RS transmission. If the TA or UL timing can be unchanged only for UL RS transmission (for normal UL transmission, TA or UL timing can still be adjusted to keep UL synchronization), a guard time window may be defined for UL RS transmission to avoid interference to normal UL transmission.

In solution 1 and solution 2, the coupling relationship or time offset between DL RS and UL RS can be known. In solution 1, same DL RS and UL RS can be applied for measurement by the UE and the gNB. Otherwise, the RTT cannot be estimated. In solution 2, if UE does not know which UL RS can be used for the gNB Rx-Tx time difference measurement, the UE may not correctly adjust the UE Rx-Tx time difference.

To determine the coupling relationship between DL RS and UL RS, resource pair can be introduced. A core network (CN) may associate the configured DL RS resources and UL RS resources and then may transfer to the UE and/or the gNB through pairing form/arrangement. In current TN positioning, the CN may only indicate the DL RS information to the UE, including a PRS ID and resources. While if the pairing form/arrangement is introduced in signaling, the CN may indicate a pair of resources for DL RS and UL RS respectively by using only one resource ID (e.g., defined as pair-resourceID). For example, resource of PRS1 and resource of SRS1 can be combined and regarded as resource of Pair1={PRS1, SRS1}. The CN may indicate the resource ID (e.g., 1 for Pair1) and corresponding time and frequency resources for DL RS (e.g., PRS1) and UL RS (e.g., SRS1). Similarly, the CN may also indicate resource to the gNB. The gNB may be able to know the coupling relationship between the DL RS and the UL RS. Moreover, the CN may further indicate multiple pairs of resources or resource set for pairs to UE as candidates or combined for positioning. The CN may indicate the resource set ID (e.g., 1 for {Pair1, Pair2, Pair3}) for the resource set of pairs.

DL RS and UL RS resources may be aperiodic or periodic. If aperiodic resources are configured, the aperiodic resources can be paired. If periodic resources are configured, which of the periodic resources are paired may be considered. At least one of following approaches may be considered.
(i) The nearest DL RS and UL RS can be paired. The nearest may refer to that the absolute time interval between DL RS receiving and UL RS transmission is minimal. Alternatively, the nearest may refer to that the logical timing interval between DL RS and UL RS is minimal.
(ii) A DL RS and a UL RS can be paired based on ordinal number after SFN #0 slot #0. For example, the first DL RS after SFN #0 slot #0 can be associated with first UL RS after SFN #0 slot #0. The second DL RS after SFN #0 slot #0 can be associated with second UL RS after SFN #0 slot #0.
(iii) A DL RS and a UL RS can be paired based on a time offset. For example, a DL RS will be associated with a UL RS, which is located after a time offset with respective to the DL RS. The time offset could be indicated by CN. If the time offset is consistent for the periodic DL RS and UL RS resource, indication of one time offset may be enough. If the time offset is not consistent, e.g., when the period of DL RS and UL RS are not same, more than one time offsets may be configured for different pairs.
(iv) A DL RS and a UL RS can be paired based on timestamps. For example, the CN may indicate a SFN and slot number for paired DL RS and UL RS, which uniquely indicate which resources of the periodic resources are paired.
(v) A DL RS and a UL RS can be paired based on resource ID. For example, the CN may indicate respective resource IDs for paired DL RS and UL RS, which uniquely indicate which resources of the periodic resources are paired.

In some embodiments, the signaling of resource pair can be implemented in various ways. For CN transferring the resource pair for positioning, at least one of following approaches can be considered.
(i) The CN may directly indicate time and frequency resources of paired DL RS and UL RS to the UE and/or the gNB. The CN may associate the resource pair with resource ID and/or resource set ID. The CN may indicate resource ID and/or resource set ID to identify the resource pair used for positioning.
(ii) The CN may transfer the pairing relationship between RSs used for measurement to the UE and/or the gNB. The UE and/or gNB may identify the time and frequency resources based on specific configuration. For example, PRS resource indication from the LMF to the UE can be supported. While SRS configuration from the gNB to the UE can be also supported. The UE can identify which PRS and SRS resources are paired for measurement with the CN simply indicating at least one of the resource ID, timestamp or time offset of corresponding PRS and SRS. In such case, the resource ID/resource set ID for the resource pair may or may not be indicated. The indication of pairing relationship may be implemented through at least one of followings.
(a) The CN may indicate the timestamps of pairs of DL RS and UL RS, including at least one of: a hyper frame number of DL RS, a system frame number of DL RS, a subframe number of DL RS, a slot number of DL RS, a symbol number of DL RS, a hyper frame number of UL RS, a system frame number of UL RS, a subframe number of UL RS, a slot number of UL RS, or a symbol number of UL RS.
(b) The CN may indicate at least one timestamp of DL RS and at least one time offset for associated UL RS. The timestamp may comprise at least one of: a hyper frame number of DL RS, a system frame number of DL RS, a subframe number of DL RS, a slot number of DL RS, or a symbol number of DL RS. The time offset may be expressed by with granularity of hyper-frames/frames/subframes/slots or seconds/milliseconds.
(c) The CN may indicate at least one timestamp of UL RS and at least one time offset for associated DL RS. The timestamp may comprise at least one of: a hyper frame number of UL RS, a system frame number of UL RS, a subframe number of UL RS, a slot number of UL RS, or a symbol number of UL RS. The time offset may be expressed with granularity of hyper-frames/frames/subframes/slots or seconds/milliseconds.
(d) The CN may indicate at least one timestamp for UL RS with respect to the indicated DL RS resource/resource set. In TN positioning, the LMF may indicate the DL RS resource/resource set to UE for measurement. The CN may additionally indicate the timestamp for associated UL RS with respect to the indicated DL RS. A list of timestamps may be indicated when more than one DL RSs are configured. The timestamp comprises at least one of: a hyper frame number of UL RS, a system frame number of UL RS, a subframe number of UL RS, a slot number of UL RS, or a symbol number of UL RS.
(e) The CN may indicate at least one time offset for UL RS with respect to the indicated DL RS resource/resource set. In TN positioning, the LMF may indicate the DL RS resource/resource set to UE for measurement. The CN may additionally indicate the time offset for associated UL RS with respect to the indicated DL RSs. A list of time offsets may be indicated when more than one DL RSs are configured and the time offsets are varied for different pairs of DL RS and UL RS. The time offset may be expressed with granularity of hyper-frames/frames/subframes/slots or seconds/milliseconds.
(f) The CN may indicate respective resource IDs of pairs of DL RS and UL RS. The detailed time and frequency resources corresponding to the resource ID of DL RS may be indicated by CN, e.g., in NR-DL-PRS-AssistanceData. The detailed time and frequency resources corresponding to the resource ID of UL RS may be indicated by base station, e.g., in SRS-config.
(g) The CN may indicate at least one resource ID for UL RS with respect to the indicated DL RS resource/resource set. In TN positioning, the LMF may indicate the DL RS resource/resource set to UE for measurement. The CN may additionally indicate the resource ID for associated UL RS with respect to the indicated DL RSs. The detailed time and frequency resources corresponding to the resource ID of UL RS may be indicated by base station, e.g., in SRS-config.

Other than/besides the approaches of CN determining and transferring the resource pair as illustrated above, it may be also possible that UE transfers determining the pairing relationship between RSs used for measurement and transfer to the LMF and/or the gNB. First, the UE may be able to know the DL RS resources based on legacy signaling from the LMF introduced for TN positioning. Moreover, the UE may be able to know the UL RS resources from gNB configuration. Then, the UE may determine how the DL RS and UL RS resources are paired and then transfer the pairing relationship to LMF and/or gNB. The indication of pairing relationship may be implemented through at least one of followings:
(1) The UE may indicate at least one timestamp of UL RS corresponding to the at least one DL RS used for UE Rx-Tx time difference measurement, including at least one of: a hyper frame number of UL RS, a system frame number of UL RS, a subframe number of UL RS, a slot number of UL RS, or a symbol number of UL RS. A list of timestamps may be indicated when more than one DL RSs or UL RSs are combined for measurement (e.g., through filtering or averaging).
(2) The UE may indicate at least one time offset of UL RS corresponding to the at least one DL RS used for UE Rx-Tx time difference measurement. A list of time offsets may be indicated when more than one DL RSs or UL RSs are combined for measurement (e.g., through filtering or averaging). The time offset may be expressed by with granularity of hyper-frames/frames/subframes/slots or seconds/milliseconds.
(3) The UE may indicate at least one resource ID of UL RS corresponding to the at least one DL RS used for UE Rx-Tx time difference measurement. The detailed time and frequency resources corresponding to the resource ID of UL RS can be known by CN or BS.

In positioning, multiple measurements may be performed. For example, in multi-RTT method, more than RTTs corresponding to different anchor points are utilized to determine a UE position. Therefore, the CN may indicate a resource set for pairs of DL RS and UL RS. A resource set for pairs may comprise multiple resource pairs. Each resource set for pairs may correspond to a resource set ID. The indication methods for resource pair can be considered for indication of resource set of pairs. At least one of following examples may be considered.

Example 1: The CN may indicate multiple pairs of resource IDs, e.g., in a list for a resource set. The indicated resource set may correspond to a resource set ID. For example, the CN may use a signaling to indicate the respective resource IDs for a pair of DL RS and UL RS, e.g., defined as Pairx={DLRSx,ULRSx}. DLRSx can be the resource ID of DL RS in the pair and ULRSx is the resource ID for UL RS in the pair. A resource ID x may also be indicated in the signaling Pairx, e.g., optionally Pairx={x,DLRSx,ULRSx}. When indicating the resource set, a list of signalings for resource pair may be indicated, e.g., {Pair1, Pair2, Pair3, Pair4, . . . }. An associated resource set ID may be indicated together with the list for resource set.

Example 2: The CN may indicate multiple pairs of timestamps corresponding to the paired RSs, e.g., in a list for a resource set. The indicated resource set may correspond to a resource set ID. For example, CN may use a signaling to indicate the respective resource IDs for a pair of DL RS and UL RS, e.g., defined as Pairx={TDLx, TULx}. TDLx can be the timestamp of DL RS in the pair and TULx is the timestamp for UL RS in the pair. A resource ID x may also be indicated in the signaling Pairx, e.g., optionally Pairx={x, TDLx, TULx}. When indicating the resource set, a list of signalings for resource pair may be indicated, e.g., {Pair1, Pair2, Pair3, Pair4, . . . }. An associated resource set ID may be indicated together with the list for resource set.

Example 3: The CN may indicate the resource of DL RS, e.g., in NR-DL-PRS-AssistanceData. In the signaling of DL RS indication, the CN may additionally indicate at least one of a resource ID, a timestamp, or a time offset of associated UL RS. For example, following IE can be included in NR-DL-PRS-AssistanceData, which indicates the detailed configuration of PRS. A UL RS resource ID may be added in this IE to indicate the associated UL RS paired with this PRS resource.

NR-DL-PRS-Resource-r16 ::= SEQUENCE {

| | |
|---|---|
| nr-DL-PRS-ResourceID-r16 | NR-DL-PRS-ResourceID-r16, |
| dl-PRS-SequenceID-r16 | INTEGER (0.. 4095), |
| dl-PRS-CombSizeN-AndReOffset-r16 | CHOICE { |
| n2-r16 | INTEGER (0..1), |
| n4-r16 | INTEGER (0..3), |
| n6-r16 | INTEGER (0..5), |
| n12-r16 | INTEGER (0..11), |

...
},

| | |
|---|---|
| dl-PRS-ResourceSlotOffset-r16 | INTEGER (0..nrMaxResourceOffsetValue-1-r16), |
| dl-PRS-ResourceSymbolOffset-r16 | INTEGER (0..12), |
| dl-PRS-QCL-Info-r16 | DL-PRS-QCL-Info-r16 |

```
  OPTIONAL, --Need ON
  ...,
  [[
```

| | |
|---|---|
| dl-PRS-ResourcePrioritySubset-r17 | DL-PRS-ResourcePrioritySubset-r17OPTIONAL |

```
  -- Need ON
  ]]
}
```

Example 4: The CN may indicate multiple resource sets, which corresponds to different satellite/TRP/BS. This may be possible for multi-sat scenario. The indication method of a resource set can be same as previous examples. The ID of the TRP, e.g., nr-CellGlobalID or nr-PhysCellID, may be indicated together with a resource set ID. For example, the indication contains the information {TRP ID, resource set ID, list of resource pairs for this resource set}, where the resource set corresponding to a TRP can be indicated. When multiple of such indications are indicated, resource set for different TRPs can be known.

Considering multiple pairs of RSs may be indicated, which pair is used for the measurement may be reported. Then the CN may be able to identify the association relationship between the measurement results and TRPs. For example, the UE may indicate the resource ID/resource set ID of the pair of RSs, or resource ID/resource set ID of the UL RS paired with DL RS used for measurement in the signaling for measurement result, e.g., the signaling for transferring UE Rx-Tx time difference. For example, the BS may indicate the resource ID/resource set ID of the pair of RSs, or resource ID/resource set ID of the DL RS paired with UL RS used for measurement in the signaling for measurement result, e.g., the signaling for transferring gNB Rx-Tx time difference.

In NTN, due to large timing drift, UE may not able to combine multiple PRS resources to determine UE Rx-Tx time difference when the resources have large interval. However, if multiple DL RSs with very short time interval are configured, the timing drift may not be significant even in NTN scenarios and combining of a few DL RSs for measurement may be possible. In some embodiments, the UE may able to estimate the DL timing drift, e.g., based on the satellite ephemeris and common TA parameters. Then the UE may mitigate the DL timing drift and combine multiple DL RSs for measurement. Hence, combining multiple DL RSs to determine the UE Rx-Tx time difference may be considered. The CN may indicate which of the configured RSs can be combined for measurement. For example, in the signaling of resource set for pairs of RSs, the CN may additionally indicate at least one list of resource IDs of pairs that can be combined for measurement, e.g., to determine UE Rx-Tx time difference. For example, in the signaling of resource set for pairs of RSs, CN may additionally indicate a value, which indicates how many adjacent pairs of RSs can be combined for measurement, e.g., to determine UE Rx-Tx time difference. The UE may filter the receive timing of multiple DL RSs to determine the Rx timing of UE Rx-Tx time difference. Alternatively, the UE may filter UE Rx-Tx time difference measurement results based on multiple DL RSs and report the filtered result.

The CN above may refer to at least one of an access and mobility management function (AMF), a location management function (LMF), an enhanced serving mobile location center (E-SMLC), or secure user plane location (SUPL) location platform (SLP) modules. The CN may transfer time information mentioned above to the UE using NR positioning protocol (NRPP). The signaling may be sent via an N1 interface. The CN may transfer time information mentioned above to the gNB using NR positioning protocol A (NRPPa). The signaling may be sent via an NG interface or an N2 interface. The UE may transfer time information mentioned above to the CN using NRPP. The signaling may be sent via an N1 interface. The UE may transfer time information mentioned above to the gNB via a Uu interface. The gNB may then transfer it to the CN via an N2 interface. Moreover, the time offset mentioned above can be indicated using logical timing (e.g., difference of SFN or subframe number or slot number based on same reference timing) or directly an absolute time difference. The time offset may be counted from the start of DL RS resource/resource set to the start of UL RS resource/resource set, or from the end of DL RS resource/resource set to the start of UL RS resource/resource set. The start may refer to the start time instance of the frame/subframe/slot/symbol of the DL RS or UL RS resource/resource set. The end may refer to the end time instance of the frame/subframe/slot/symbol of the DL RS or UL RS resource/resource set.

For detailed implementation of resource pair indication and time drift mitigation, at least one of following examples may be possible.

Example 1: The CN may indicate the time and/or frequency resources of paired DL RS and UL RS to UE in the LTE positioning protocol (LPP) assistance data. The CN may also indicate the time and/or frequency resources of paired DL RS and UL RS to the gNB in LPP signaling. The UE may measure the UE Rx-Tx time difference based on measurement of DL RS. Then the UE can estimate the variation of UL timing or TA for UL RS transmission with respect to DL RS receiving. The UE may adjust the UE Rx-Tx time difference based on the estimated UL timing variation or TA variation and then transfer to the CN, e.g., using LPP signaling. The gNB may measure the gNB Rx-Tx time difference based on received UL RS and then transfer to the CN, e.g., using LPP signaling. The LMF may derive RTT based on the UE Rx-Tx time difference and gNB Rx-Tx time difference.

Example 2: The CN may indicate the time and/or frequency resources of paired DL RS and UL RS to UE in the LPP assistance data. Moreover, the CN may also indicate the time and/or frequency resources of paired DL RS and UL RS to the gNB in LPP signaling. The UE may derive the UE Rx-Tx time difference as the time difference between measured DL RS receiving time and UL RS transmitting time for the resource pair. Then the UE may transfer it to the CN, e.g., using LPP signaling. Correspondingly, the gNB may derive the gNB Rx-Tx time difference as time difference between DL RS transmitting time and measured UL RS receiving time for same resource pair. Then the gNB can transfer it to the CN, e.g., using LPP signaling. The LMF may derive RTT based on the UE Rx-Tx time difference and gNB Rx-Tx time difference.

Example 3: The CN may indicate the timestamps of paired DL RS and UL RS to UE in the LPP assistance data. The CN may also indicate the timestamps of paired DL RS and UL RS to the gNB in LPP signaling. The UE/gNB may identify time and frequency resources of paired DL RS and UL RS. The UE/gNB may measure and transfer UE/gNB Rx-Tx time difference as in example 1.

Example 4: The CN may indicate the timestamps of paired DL RS and UL RS to the UE in the LPP assistance data. The CN may also indicate the timestamps of paired DL RS and UL RS to gNB in LPP signaling. The UE/gNB may identify time and frequency resources of paired DL RS and UL RS. Then the UE/gNB may measure and transfer UE/gNB Rx-Tx time difference as in example 2.

Example 5: The CN may indicate the timestamp of DL RS and a time offset for associated UL RS to UE in the LPP assistance data. The CN may also indicate the timestamp of DL RS and a time offset for associated UL RS to the gNB in LPP signaling. The UE/gNB may identify time and frequency resources of paired DL RS and UL RS. Then the UE/gNB may measure and transfer UE/gNB Rx-Tx time difference as in example 1.

Example 6: The CN may indicate the timestamp of DL RS and a time offset for associated UL RS to the UE in the LPP assistance data. The CN may also indicate the timestamp of DL RS and a time offset for associated UL RS to the gNB in LPP signaling. The UE/gNB may identify time and frequency resources of paired DL RS and UL RS. Then the UE/gNB may measure and transfer UE/gNB Rx-Tx time difference as in example 2.

Example 7: The CN may indicate the timestamp of UL RS and a time offset for associated DL RS to UE in the LPP assistance data. The CN may also indicate the timestamp of UL RS and a time offset for associated DL RS to the gNB in LPP signaling. The UE/gNB may identify time and frequency resources of paired DL RS and UL RS. Then the UE/gNB may measure and transfer UE/gNB Rx-Tx time difference as in example 1.

Example 8: The CN may indicate the timestamp of UL RS and a time offset for associated DL RS to the UE in the LPP assistance data. The CN may also indicate the timestamp of UL RS and a time offset for associated DL RS to the gNB in LPP signaling. The UE/gNB may identify time and frequency resources of paired DL RS and UL RS. Then the UE/gNB may measure and transfer UE/gNB Rx-Tx time difference as in example 2.

Example 9: The CN may indicate the timestamp/resource ID/time offset for UL RS in the LPP assistance data to the UE. The CN may also indicate the timestamp/resource ID/time offset to the gNB in LPP signaling, e.g., in requested UL-SRS transmission characteristics information, or TRP measurement request information, or positioning activation/deactivation request information. Each DL RS resource/resource set or each instance of periodic DL resource can be associated with a timestamp/resource ID/time offset for UL RS. The UE may identify the corresponding UL RS and estimate the variation of UL timing or TA for UL RS transmission. The UE may adjust the UE Rx-Tx time difference based on the estimated UL timing variation or TA variation and then transfer to CN, e.g., using LPP signaling. The gNB may measure the gNB Rx-Tx time difference based on received UL RS and then transfer to CN, e.g., using LPP signaling. The LMF may derive RTT based on the UE Rx-Tx time difference and gNB Rx-Tx time difference.

Example 10: The CN may indicate the timestamp/resource ID/time offset for UL RS in the LPP assistance data to the UE. Moreover, the CN may also indicate the timestamp/resource ID/time offset to the gNB in LPP signaling, e.g., in requested UL-SRS transmission characteristics information, or TRP measurement request information, or positioning activation/deactivation request information. Each DL RS resource/resource set or each instance of periodic DL resource can be associated with a timestamp/resource ID/time offset for UL RS. The UE may derive the UE Rx-Tx time difference as the time difference between measured DL RS receiving time and UL RS transmitting time. Then the UE may transfer it to CN, e.g., using LPP signaling. Correspondingly, the gNB may derive the gNB Rx-Tx time difference as time difference between DL RS transmitting time and measured UL RS receiving time for same DL RS and UL RS pair. Then the gNB can transfer it to the CN, e.g., using LPP signaling. Finally, the LMF may derive RTT based on the UE Rx-Tx time difference and gNB Rx-Tx time difference.

Example 11: The UE can be indicated with DL RS resource/resource set by signaling from CN and configured with UL RS transmission by signaling from the gNB. Hence, the UE may autonomously determine the association between DL RS and UL RS. Similar to example 9, the UE may estimate the variation of UL timing or TA for UL RS transmission and adjust the UE Rx-Tx time difference. Then the UE may transfer the UE Rx-Tx time difference to CN, e.g., using LPP signaling. In order to let the CN know the association, the UE may additionally transfer the timestamp/resource ID/time offset of the associated UL RS to the CN, e.g., along with the measurement result through LPP signaling.

Example 12: The UE can be indicated with DL RS resource/resource set by signaling from CN and configured with UL RS transmission by signaling from the gNB. Hence, the UE may autonomously determine the association between DL RS and UL RS. Similar to example 10, the UE may derive the UE Rx-Tx time difference as the time difference between measured DL RS receiving time and UL RS transmitting time. Then the UE may transfer it to the CN, e.g., using LPP signaling. In order to let the gNB know the association and perform correct gNB Rx-Tx time difference measurement, the UE may report the timestamp/resource ID/time offset of the associated UL RS to the gNB through MAC CE or RRC signaling. Moreover, the CN can also know the association. Hence, the UE may also transfer the timestamp/resource ID/time offset of the associated UL RS to the CN, e.g., along with the measurement result through LPP signaling.

Example 13: The gNB may exchange the DL RS and UL RS information with the CN. Hence, the gNB may autonomously determine the association between DL RS and UL RS and indicate the timestamp/resource ID/time offset for UL RS with respect to DL RS, e.g., using MAC CE or RRC signaling. Similar to example 9, the UE may estimate the variation of UL timing or TA for UL RS transmission and adjust the UE Rx-Tx time difference. Then the UE may transfer the UE Rx-Tx time difference to CN, e.g., using LPP signaling. The gNB may transfer corresponding gNB Rx-Tx time difference to CN based on same UL RS, e.g., using LPP signaling. When more than one DL RS and UL RS pairs exist, the CN may need to know the association of UE Rx-Tx time difference and gNB Rx-Tx time difference. In order to let CN know the association, the UE may additionally transfer the timestamp/resource ID/time offset of the associated UL RS to the CN, e.g., along with the measurement result through LPP signaling. The gNB may additionally transfer the timestamp/resource ID/time offset of the associated DL RS to the CN, e.g., along with the measurement result through LPP signaling.

Example 14: The gNB may exchange the DL RS and UL RS information with the CN. Hence, the gNB may autonomously determine the association between DL RS and UL RS and indicate the timestamp/resource ID/time offset for UL RS with respect to DL RS, e.g., using MAC CE or RRC signaling. Similar to example 10, the UE may derive the UE Rx-Tx time difference as the time difference between measured DL RS receiving time and UL RS transmitting time. Then the UE may transfer it to the CN, e.g., using LPP signaling. Correspondingly, the gNB may derive the gNB Rx-Tx time difference as time difference between DL RS transmitting time and measured UL RS receiving time for same DL RS and UL RS pair. Then the gNB can transfer it to the CN, e.g., using LPP signaling. Finally, the LMF may derive RTT based on the UE Rx-Tx time difference and gNB Rx-Tx time difference.

The above methods may also be applied to other positioning approaches besides the multi-RTT method, such as UL-TDOA, DL-TDOA, DL-AoD, and UL-AoA, which also utilize geometric calculation based on measurements for positioning. For example, it can also be applied for DL-TDOA, where the UE may measure the RSTD based on multiple DL RSs. The timing relationship between different DL RSs may be known to mitigate the error caused by timing drift. In such case, timestamps of DL RS pairs or time offset between different DL RSs may be indicated, instead of between DL RS and UL RS.

Moreover, the above methods can be applied for either single-satellite or multiple-satellite scenarios. For single satellite scenarios, as illustrated in implementation example 1, satellite positions at different time instances can be regarded as different anchor nodes. In this case, the timestamp/time offset between RSs can be indicated using the timing corresponding to the same satellite/gNB/TRP. For multiple-satellite scenarios, different satellites/gNBs/TRPs may be considered as different anchor points. Since different timing may be used for different satellites/gNBs/TRPs, the timestamp for RSs may be indicated using the timing corresponding to the satellite/gNB/TRP. Alternatively, the timestamp for RSs may be indicated using a reference timing, e.g., the timing of serving satellite/gNB/TRP. As for time offset between RSs, conversion between different timings may be utilized. A simple method can be to define a reference timing, e.g., the timing of serving satellite/gNB/TRP, where the time offset is determined based on the reference timing. Another method can be that LMF indicate the offset of timings for different satellites/gNBs/TRPs, e.g., indicating the offset of SFNO, which may be expressed as number of frames/subframes/slots.

It should be understood that one or more features from the above implementation examples are not exclusive to the specific implementation examples, but can be combined in any manner (e.g., in any priority and/or order, concurrently or otherwise).

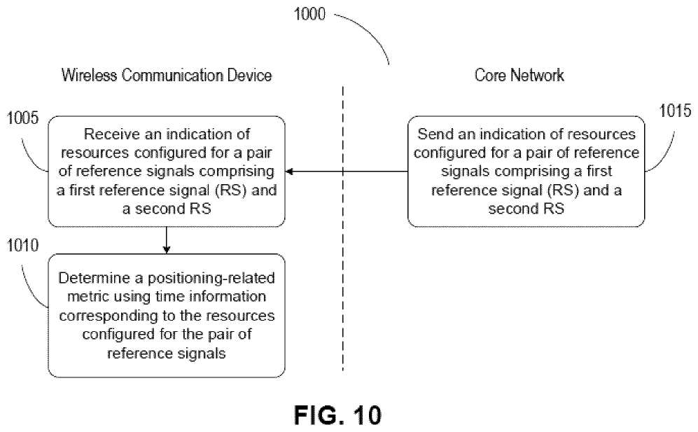

FIG. 10 illustrates a flow diagram for time information indication in positioning, in accordance with an embodiment of the present disclosure. The method 1000 may be implemented using any one or more of the components and devices detailed herein in conjunction with FIGS. 1-2. In overview, the method 1000 may be performed by a wireless communication device, in some embodiments. Additional, fewer, or different operations may be performed in the method 1000 depending on the embodiment. At least one aspect of the operations is directed to a system, method, apparatus, or a computer-readable medium.

A wireless communication device (e.g., a UE) may receive an indication of resources (e.g., time offset, timestamp) configured for a pair of reference signals comprising a first reference signal (RS) and a second RS (e.g., DL RS and UL RS (e.g., PRS and SRS)) from a core network (CN). The wireless communication device may determine (e.g., calculate) a positioning-related metric (e.g., a UE Rx-Tx time difference, a gNB Rx-Tx time difference, a reference signal time difference (RSTD)) using time information corresponding to the resources configured for the pair of reference signals. In some embodiments, in a LPP protocol, a CN (e.g., location server) may indicate NR-DL-PRS-AssistanceData to UE, which includes a time and frequency resource configuration for PRS. On the other hand, eNB/gNB's measurement can be based on SRS transmitted by the UE. Hence, before measurement, the eNB/gNB may configure the time and frequency resource for SRS to UE using SRS-Config. The eNB/gNB may exchange the SRS configuration with the CN. The indication of resources may include providing/indicating/configuring a time offset that is used to select/identify/determine the resources for the pair of reference signals, e.g., select the resources from those resources that are already configured.

In some embodiments, the UE may be aware of/know detailed PRS and SRS resources. The pairing relationship may be unknown. If a CN indicates a time offset (e.g., using number of subframes), the UE can identify which PRS and SRS are paired and then can determine the detailed resources. In certain embodiments, there may be no need to let CN indicate the detailed resources again in additional signaling.

In some embodiments, the indication of resources may comprise at least one of: an indication of one or more resources configured for the first RS, and one or more resources configured for the second RS. The indication of resources may comprise a resource identifier (ID), selected from a plurality of resource IDs corresponding to a plurality of pairs of reference signals.

In some embodiments, the resources may include periodic resources, aperiodic resources, or both periodic and aperiodic resources. The pair of reference signals can be determined according to one of following approaches: the second RS is a nearest RS to the first RS; the first RS is an RS of a first type (e.g., DL RS (e.g. PRS)) located closest to and after a reference point (e.g., SFN #0 slot #0), and the second RS is an RS of a second type (e.g., UL RS (e.g., SRS)) located closest to and after the reference point; the first RS and the second RS are separated by a defined time offset; or the first RS and the second RS are identified by respective timestamps (e.g., SFN and slot number for each RS) or time indications.

In some embodiments, when a resource for the first RS is an aperiodic resource, the pair of reference signals can be determined according to one of following approaches: the second RS is a nearest RS to first RS with the aperiodic resource; the second RS is a RS identified by a timestamp or time indication; or the second RS is a RS identified by a defined time offset with respect to first RS. The indication of resources may comprise at least one of: an indication of a resource ID of the first RS; an indication of a resource ID of the second RS; an indication of a timestamp or time indication (e.g., SFN and slot number for each RS) of the first RS; an indication of a timestamp or time indication of the second RS; an indication of a timestamp or time indication of the first RS, with respect to the second RS; an indication of a timestamp or time indication of the second RS, with respect to the first RS; or a defined time offset separating the first RS and the second RS. Each timestamp or time indication of a corresponding RS may comprise at least one of: a hyper frame number (HFN); a system frame number (SFN); a subframe number; a slot number; a symbol number; or an absolute time with granularity of a defined number of microseconds or nanoseconds. The defined offset may comprise at least one of: a hyper frame number (HFN); a system frame number (SFN); a subframe number; a slot number; a symbol number; or an absolute time with granularity of a defined number of seconds, milliseconds, microseconds or nanoseconds.

In some embodiments, the CN may communicate to the wireless communication node, the indication of resources (e.g., time offset, timestamp) configured for the pair of reference signals.

In some embodiments, the positioning-related metric (e.g., UE rx-tx time difference, gNB rx-tx time difference, RSTD) may comprise at least one of: a user equipment or the wireless communication device's (UE) receive-transmit (Rx-Tx) time difference between subframes carrying the reference signals; a UE Rx-Tx time difference between a received time of a downlink (DL) subframe carrying the first RS, and a transmit time of a nearest or corresponding uplink (UL) subframe; a UE Rx-Tx time difference between a received time of a DL subframe, and a transmit time of an UL subframe carrying the second RS, and the DL subframe is a DL subframe nearest or corresponding to the UL subframe; a base station or the wireless communication node's (gNB) Rx-Tx time difference between the subframes carrying the reference signals; a gNB Rx-Tx time difference between a received time of an UL subframe carrying the second reference signal and a transmit time of a nearest or corresponding DL subframe; a round trip time (RTT) between the wireless communication device and the wireless communication node; a relative time of arrival (RTOA); an DL or UL angle of departure (AoD); an UL or DL angle of arrival (AoA); or a reference signal time difference (RSTD). In some embodiments, the wireless communication node comprises the satellite. In some embodiments, the reference point for RTOA, UL-AoA, gNB Rx-Tx time difference measurement may be at least one of: on board a satellite, at the UL time synchronization reference point, at the gateway, at ground base station. In some embodiments, some of the abovementioned metrics (e.g., gNB Rx-Tx time difference, RTOA, UL-AoA, DL-AoD) can be determined/calculated by the wireless communication node (e.g., a gNB, a BS, a transmit-receive point, or a satellite) and/or the wireless communication device.

In some embodiments, the first signal may comprise a downlink RS or a positioning RS (PRS), and the second signal comprises an uplink RS or a sounding RS (SRS). The first signal may comprise a first downlink or uplink RS, and the second signal comprises a second downlink or uplink RS.

In some embodiments, a core network (CN) may send an indication (e.g., time offset, timestamp) of resources configured for a pair of reference signals comprising a first reference signal (RS) and a second RS (e.g., DL RS and UL RS (e.g., PRS and SRS)). The wireless communication device may determine a positioning-related metric (e.g., UE rx-tx time difference, gNB rx-tx time difference, RSTD) using time information corresponding to the resources configured for the pair of reference signals.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
receiving, by a wireless communication device from a core network (CN), an indication of resources configured for a pair of reference signals comprising a first reference signal (RS) and a second RS; and
determining, by the wireless communication device, a positioning-related metric using time information corresponding to the resources configured for the pair of reference signals.

2. The method of claim 1, wherein the indication of resources comprises at least one of:
an indication of one or more resources configured for the first RS, and one or more resources configured for the second RS.

3. The method of claim 2, wherein the indication of resources comprises a resource identifier (ID), selected from a plurality of resource IDs corresponding to a plurality of pairs of reference signals.

4. The method of claim 1, wherein the pair of reference signals is determined according to one of following approaches:
the second RS is a nearest RS to the first RS;
the first RS is an RS of a first type located closest to and after a reference point, and the second RS is an RS of a second type located closest to and after the reference point;
the first RS and the second RS are separated by a defined time offset;
the first RS and the second RS are identified by respective resource IDs; or
the first RS and the second RS are identified by respective timestamps or time indications.

5. The method of claim 1, wherein when a resource for the first RS is an aperiodic resource, the pair of reference signals is determined according to one of following approaches:
the second RS is a nearest RS to first RS with the aperiodic resource;
the second RS is a RS identified by a timestamp or time indication;
the second RS is a RS identified by a resource ID; or
the second RS is a RS identified by a defined time offset with respect to first RS.

6. The method of claim 2, wherein the indication of resources comprises at least one of:
an indication of a timestamp or time indication of the first RS;
an indication of a timestamp or time indication of the second RS;
an indication of a resource ID of the first RS;
an indication of a resource ID of the second RS;
an indication of a timestamp or time indication of the first RS, with respect to the second RS;
an indication of a timestamp or time indication of the second RS, with respect to the first RS; or
a defined time offset separating the first RS and the second RS.

7. The method of claim 6, wherein each timestamp or time indication of a corresponding RS comprises at least one of:
a hyper frame number (HFN);
a system frame number (SFN);
a subframe number;
a slot number;
a symbol number; or
an absolute time with granularity of a defined number of microseconds or nanoseconds.

8. The method of claim 6, wherein the defined offset comprises at least one of:
a hyper frame number (HFN);
a system frame number (SFN);
a subframe number;
a slot number;
a symbol number; or
an absolute time with granularity of a defined number of seconds, milliseconds, microseconds or nanoseconds.

9. The method of claim 1, wherein the CN communicates to the wireless communication node, the indication of resources configured for the pair of reference signals.

10. The method of claim 1, wherein the positioning-related metric comprises at least one of:
a user equipment or the wireless communication device's (UE) receive-transmit (Rx-Tx) time difference between subframes carrying the reference signals;
a UE Rx-Tx time difference between a received time of a downlink (DL) subframe carrying the first RS, and a transmit time of a nearest or corresponding uplink (UL) subframe;
a UE Rx-Tx time difference between a received time of a DL subframe, and a transmit time of an UL subframe carrying the second RS, and the DL subframe is a DL subframe nearest or corresponding to the UL subframe;
a base station or the wireless communication node's (gNB) Rx-Tx time difference between the subframes carrying the reference signals;
a gNB Rx-Tx time difference between a received time of an UL subframe carrying the second reference signal and a transmit time of a nearest or corresponding DL subframe;
a round trip time (RTT) between the wireless communication device and the wireless communication node;
a relative time of arrival (RTOA);
an DL or UL angle of departure (AoD);
an UL or DL angle of arrival (AoA); or
a reference signal time difference (RSTD).

11. The method of claim 1, wherein the first signal comprises a downlink RS or a positioning RS (PRS), and the second signal comprises an uplink RS or a sounding RS (SRS).

12. The method of claim 1, wherein the first signal comprises a first downlink or uplink RS, and the second signal comprises a second downlink or uplink RS.

13. A method comprising:
sending, by a core network (CN) to a wireless communication device, an indication of resources configured for a pair of reference signals comprising a first reference signal (RS) and a second RS,
wherein the wireless communication device determines a positioning-related metric using time information corresponding to the resources configured for the pair of reference signals.

14. A core network (CN) node, comprising:
at least one processor configured to:
send, via a transmitter to a wireless communication device, an indication of resources configured for a pair of reference signals comprising a first reference signal (RS) and a second RS,
wherein the wireless communication device determines a positioning-related metric using time information corresponding to the resources configured for the pair of reference signals.

15. A wireless communication device, comprising:
at least one processor configured to:
receive, via a receiver from a core network (CN), an indication of resources configured for a pair of reference signals comprising a first reference signal (RS) and a second RS; and
determine a positioning-related metric using time information corresponding to the resources configured for the pair of reference signals.

16. The wireless communication device of claim 15, wherein the indication of resources comprises at least one of:
an indication of one or more resources configured for the first RS, and one or more resources configured for the second RS.

17. The wireless communication device of claim 16, wherein the indication of resources comprises a resource identifier (ID), selected from a plurality of resource IDs corresponding to a plurality of pairs of reference signals.

18. The wireless communication device of claim 15, wherein the pair of reference signals is determined according to one of following approaches:
the second RS is a nearest RS to the first RS;
the first RS is an RS of a first type located closest to and after a reference point, and the second RS is an RS of a second type located closest to and after the reference point;
the first RS and the second RS are separated by a defined time offset;
the first RS and the second RS are identified by respective resource IDs; or
the first RS and the second RS are identified by respective timestamps or time indications.

19. The wireless communication device of claim 15, wherein when a resource for the first RS is an aperiodic resource, the pair of reference signals is determined according to one of following approaches:
the second RS is a nearest RS to first RS with the aperiodic resource;
the second RS is a RS identified by a timestamp or time indication;
the second RS is a RS identified by a resource ID; or
the second RS is a RS identified by a defined time offset with respect to first RS.

20. The wireless communication device of claim 16, wherein the indication of resources comprises at least one of:
an indication of a timestamp or time indication of the first RS;
an indication of a timestamp or time indication of the second RS;
an indication of a resource ID of the first RS;
an indication of a resource ID of the second RS;
an indication of a timestamp or time indication of the first RS, with respect to the second RS;
an indication of a timestamp or time indication of the second RS, with respect to the first RS; or
a defined time offset separating the first RS and the second RS.
